(19) United States
(12) Patent Application Publication
(10) Pub. No.: US 2020/0168924 A1
(43) Pub. Date: May 28, 2020

(54) HYDROGEN CIRCULATION PUMP FOR FUEL CELL SYSTEM AND FUEL CELL SYSTEM

(71) Applicant: KABUSHIKI KAISHA TOYOTA JIDOSHOKKI, Aichi-ken (JP)

(72) Inventors: Fumihiro Suzuki, Kariya-shi (JP); Tatsuyuki Hoshino, Kariya-shi (JP); Hidefumi Mori, Kariya-shi (JP)

(73) Assignee: KABUSHIKI KAISHA TOYOTA JIDOSHOKKI, Aichi-ken (JP)

(21) Appl. No.: 16/686,847

(22) Filed: Nov. 18, 2019

(30) Foreign Application Priority Data
Nov. 28, 2018 (JP) 2018-222693

(51) Int. Cl. H01M 8/04089; F04B 39/12; F04B 37/18

(52) U.S. Cl. CPC H01M 8/04097; F04B 37/18; F04B 39/12

(57) ABSTRACT

A hydrogen circulation pump includes a pump body, a motor, a driver, and a housing. The housing internally includes a hydrogen recirculation passage connecting the pump body to a fuel cell stack, a hydrogen supply passage through which hydrogen is supplied from a hydrogen supply source to the fuel cell stack, and a partition wall that defines an accommodation chamber accommodating the driver. The hydrogen supply passage includes a merge portion where the hydrogen supply passage merges with the hydrogen recirculation passage. The hydrogen supply passage is arranged in the housing such that heat is exchanged at an upstream side of the merge portion through the partition wall between the driver and the hydrogen in the hydrogen supply passage.

### FIELD

The following description relates to a hydrogen circulation pump for a fuel cell system and relates to a fuel cell system.

### DESCRIPTION OF RELATED ART

Japanese Laid-Open Patent Publication No. 2014-232702 discloses a typical fuel cell system. The fuel cell system includes a hydrogen tank, a fuel cell stack, a hydrogen supply pipe, a hydrogen recirculation pipe, and a hydrogen circulation pump. The hydrogen tank is a hydrogen supply source that stores hydrogen. The fuel cell stack is a stack of fuel battery cells. The hydrogen supply pipe is configured to connect the hydrogen tank to the fuel cell stack and supply hydrogen to the fuel cell stack. The hydrogen recirculation pipe is connected to the fuel cell stack to recirculate exhaust gas containing hydrogen that has not been used in the fuel cell stack. The hydrogen circulation pump is connected to the hydrogen recirculation pipe to supply the exhaust gas in the hydrogen recirculation pipe through the hydrogen supply pipe to the fuel cell stack.

The hydrogen circulation pump includes a pump body, which delivers, to a discharge port, fluid drawn through an intake port. The pump body is driven by a motor. The motor is controlled by an inverter, which is a driver.

In the fuel cell system, the hydrogen in the hydrogen tank is supplied through the hydrogen supply pipe to the fuel cell stack, and electricity is generated through the electrochemical reaction of the hydrogen and oxygen of the atmosphere in the fuel cell stack. Exhaust gas containing hydrogen that has not been used in the fuel cell stack is drawn through the hydrogen recirculation pipe into the hydrogen circulation pump. The drawn gas is discharged to the hydrogen supply pipe and supplied to the fuel cell stack again by the pump body.

Thus, the fuel cell system reduces wasteful consumption of hydrogen.

### SUMMARY

In the hydrogen circulation pump of the fuel cell system, when the motor and the driver are accommodated in different housings, the mountability for a vehicle or the like is not sufficient. When the motor and the driver are accommodated separately apart from each other in the same housing of the pump, the durability may decrease due to the generation of heat in electric components of the inverter such as a substrate, a power module, and a capacitor.

It is an object of the present disclosure to provide a hydrogen circulation pump for a fuel cell system and a fuel cell system that have an excellent mountability and are capable of reducing deterioration in the durability.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A hydrogen circulation pump for a fuel cell system according to one aspect of the present disclosure includes a pump body configured to deliver hydrogen, a motor configured to drive the pump body, a driver configured to control the motor, and a housing that accommodates the pump body, the motor, and the driver. The housing internally includes a hydrogen recirculation passage connecting the pump body to a fuel cell stack, the hydrogen recirculation passage including an intake port into which the pump body draws the hydrogen from the fuel cell stack, a hydrogen supply passage through which hydrogen is supplied from a hydrogen supply source to the fuel cell stack, and a partition wall that defines an accommodation chamber accommodating the driver. The hydrogen supply passage includes an inflow port through which hydrogen flows into the housing, a merge portion where the hydrogen supply passage merges with the hydrogen recirculation passage, and a discharge port arranged downstream of the merge portion. The hydrogen supply passage is arranged in the housing such that heat is exchanged at an upstream side of the merge portion through the partition wall between the driver and the hydrogen in the hydrogen supply passage.

Other features and aspects will be apparent from the following detailed description, the drawings, and the claims.

### BRIEF DESCRIPTION OF THE DRAWINGS

FIG. 1 is a vertical cross-sectional view of a hydrogen circulation pump according to a first embodiment.

FIG. 2 is a horizontal cross-sectional view showing the hydrogen circulation pump of FIG. 1.

FIG. 3 is a diagram schematically showing part of the fuel cell system of FIG. 1.

FIG. 4 is a diagram schematically showing part of a fuel cell system according to a second embodiment.

FIG. 5 is a vertical cross-sectional view of a hydrogen circulation pump according to a third embodiment.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

First to third embodiments of the present disclosure will now be described with reference to the drawings.

First Embodiment

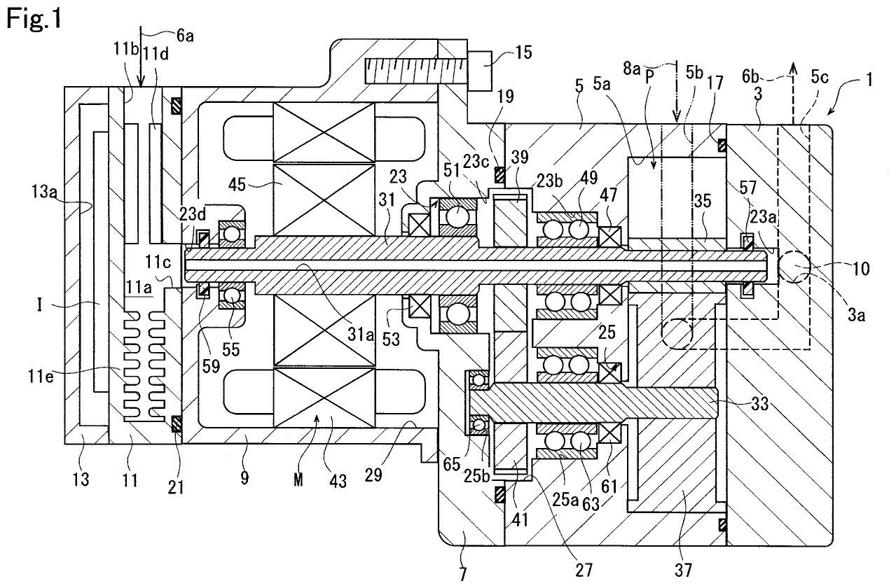

As shown in FIG. 1, the fuel cell system of the first embodiment includes a hydrogen circulation pump 1. The hydrogen circulation pump 1 includes an end housing member 3, a pump housing member 5, a center housing member 7, a motor housing member 9, a cooling housing member 11, and an inverter cover 13. These housing members are joined to one another by bolts 15.

The hydrogen circulation pump 1 includes an O-ring 17, which is arranged between the end housing member 3 and the pump housing member 5, an O-ring 19, which is arranged between the pump housing member 5 and the center housing member 7, and an O-ring 21, which is arranged between the motor housing member 9 and the cooling housing member 11. The end housing member 3, the pump housing member 5, the center housing member 7, the motor housing member 9, the cooling housing member 11, and the inverter cover 13 configure a housing.

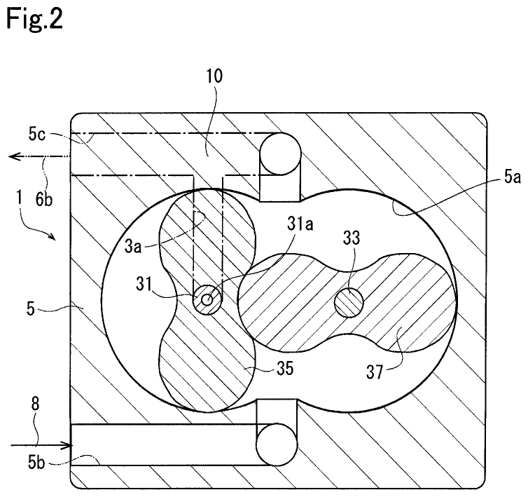

As shown in FIG. 2, the pump housing member 5 includes a pump chamber 5a and an intake passage 5b, which is connected to the pump chamber 5a. The intake passage 5b has an intake port, which opens toward the outside of the hydrogen circulation pump 1. As shown in FIGS. 1 and 2, the end housing member 3 and the pump housing member 5 include a discharge passage 5c, which is connected to the pump chamber 5a. The pump housing member 5 has an upstream portion of the discharge passage 5c extending from the pump chamber 5a, and the end housing member 3 has a downstream portion of the discharge passage 5c. The downstream portion of the discharge passage 5c has a discharge port, which opens toward the outside of the hydrogen circulation pump 1.

As shown in FIG. 1, the end housing member 3, the pump housing member 5, the center housing member 7, and the motor housing member 9 respectively have shaft holes 23a, 23b, 23c, and 23d, which are laid out along a first axis. The shaft holes 23a, 23b, 23c, and 23d are laid out in this order from a first end (right end in FIG. 1) of the first axis toward a second end (left end in FIG. 1) to configure a first shaft hole 23. The first shaft hole 23 accommodates a first rotation shaft 31, bearings 49, 51, and 55, and seals 47 and 53. The pump housing member 5 and the center housing member 7 respectively have shaft holes 25a and 25b, which are laid out along a second axis. The shaft holes 25a and 25b configure a second shaft hole 25. The second shaft hole 25 accommodates part of a second rotation shaft 33, a bearing 63, and a seal 61. The first axis of the first shaft hole 23 extends in parallel to the second axis of the second shaft hole 25.

The end housing member 3 and the pump housing member 5 have a connection passage 3a, which is connected to the shaft hole 23a. As shown in FIGS. 1 and 2, the connection passage 3a is connected to the discharge passage 5c (discharge port) at a merge portion 10.

As shown in FIG. 1, the pump housing member 5 and the center housing member 7 define a gear chamber 27. The center housing member 7 and the motor housing member 9 define a motor chamber 29. The cooling housing member 11 includes a cooling chamber 11a, which is connected to the shaft hole 23d. The cooling housing member 11 includes a partition wall 11e, which is located facing the inverter cover 13, that is, located between the cooling chamber 11a and the inverter I. Thus, a hydrogen supply passage 6 (described later) is arranged such that heat is exchanged at an upstream side of the merge portion 10 through the partition wall 11e between the hydrogen in the hydrogen supply passage 6 and an inverter I.

The first rotation shaft 31 is accommodated in the first shaft hole 23. The second rotation shaft 33 is inserted through the second shaft hole 25. The first rotation shaft 31 extends in parallel to the second rotation shaft 33. As shown in FIG. 2, the pump chamber 5a includes a first rotor 35, which is fixed to the first rotation shaft 31, and a second rotor 37, which is fixed to the second rotation shaft 33. The first and second rotors 35 and 37 are two-lobe rotors including lobes and recesses that mesh with each other.

As shown in FIG. 1, the gear chamber 27 includes a first gear 39, which is fixed to the first rotation shaft 31, and a second gear 41, which is fixed to the second rotation shaft 33. The first and second gears 39 and 41 mesh with each other. The motor chamber 29 includes a stator 43, which is fixed to the motor housing member 9, and a motor rotor 45, which is fixed to the first rotation shaft 31.

The shaft hole 23b of the pump housing member 5 is located between the pump chamber 5a and the gear chamber 27. In the shaft hole 23b, the seal 47 and the bearing 49 are laid out on the outer circumference of the first rotation shaft 31 along the first axis. The seal 47 is closer to the pump chamber 5a than the bearing 49, and the bearing 49 is closer to the gear chamber 27 than the seal 47. The shaft hole 23c of the center housing member 7 is located between the pump chamber 5a and the motor chamber 29. In the shaft hole 23c, the bearing 51 and the seal 53 are laid out on the outer circumference of the first rotation shaft 31 along the first axis. The bearing 51 is closer to the gear chamber 27 than the seal 53, and the seal 53 is closer to the motor chamber 29 than the bearing 51. Further, the shaft hole 23d of the motor housing member 9 is located between the motor chamber 29 and the cooling chamber 11a. In the shaft hole 23d, the bearing 55 and a PTFE chip seal 59 are laid out on the outer circumference of the first rotation shaft 31 along the first axis. The shaft hole 23a of the end housing member 3 is connected to the connection passage 3a. In the shaft hole 23a, a PTFE chip seal 57 is arranged along the outer circumference of the first rotation shaft 31. The chip seal 57, the seal 47, the bearing 49, the bearing 51, the seal 53, the bearing 55, and the chip seal 59 rotationally support the first rotation shaft 31 while limiting the leakage of fluid.

The shaft hole 25a of the pump housing member 5 is located between the pump chamber 5a and the gear chamber 27. In the shaft hole 25a, the seal 61 and the bearing 63 are laid out along the outer circumference of the second rotation shaft 33 on the second axis. The seal 61 is closer to the pump chamber 5a than the bearing 63, and the bearing 63 is closer to the gear chamber 27 than the seal 61. The shaft hole 25b of the center housing member 7 has a closed end, which is the left end in FIG. 1. In the shaft hole 25b, a bearing 65 is arranged along the outer circumference of the second rotation shaft 33. The seal 61, the bearing 63, and the bearing 65 rotationally support the second rotation shaft 33 while limiting the leakage of fluid.

The cooling housing member 11 has an inflow port 11b and an outflow port 11c. The cooling chamber 11a connects the inflow port 11b to the outflow port 11c. The inflow port 11b opens toward the outside of the hydrogen circulation pump 1 and is connected to an upstream supply pipe 6a. The upstream supply pipe 6a is an upstream portion of the hydrogen supply passage 6 connected to a hydrogen tank 2. The outflow port 11c is connected to a shaft passage 31a formed in the first rotation shaft 31. The cooling housing member 11 includes fins 11d, which protrude into the cooling chamber 11a.

The first rotation shaft 31 includes the shaft passage 31a, which extends through the first rotation shaft 31 in the axial direction. The cooling chamber 11a is connected to the connection passage 3a through the shaft passage 31a. The chip seals 59 and 57 limit the leakage of the hydrogen in the cooling chamber 11a into the first shaft hole 23. The hydrogen in the cooling chamber 11a flows through the shaft passage 31a into the connection passage 3a and is discharged out of the discharge passage 5c. That is, the hydrogen supply passage 6 merges with a hydrogen recirculation passage 8 at the merge portion 10 of the connection passage 3a and the discharge passage 5c. The hydrogen supply passage 6 merges with the hydrogen recirculation passage 8 at the downstream side of a pump body P. The merge portion 10 is located downstream of the pump body P.

The first rotation shaft 31, the first rotor 35, the second rotation shaft 33, and the second rotor 37 configure the pump body P. The pump body P draws hydrogen from the intake passage 5b into the pump chamber 5a and discharges the hydrogen from the pump chamber 5a to the discharge passage 5c. That is, the pump body P is configured to deliver hydrogen. The first rotation shaft 31, the motor rotor 45, and the stator 43 configure a motor M. The motor M drives the pump body P. The inverter cover 13 and the partition wall 11e define an accommodation chamber 13a. The inverter I is fixed in the accommodation chamber 13a. The inverter I is an example of the driver. The inverter I controls the motor M.

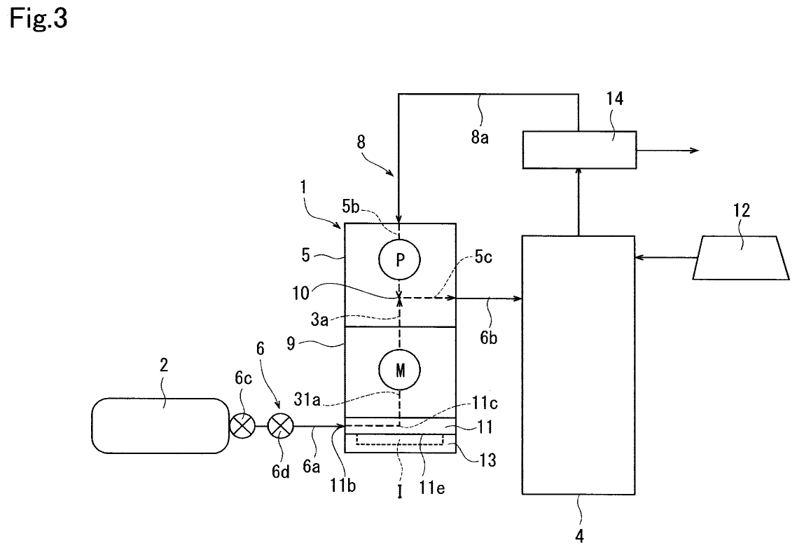

Referring to FIG. 3, the hydrogen circulation pump 1 of the first embodiment configures the fuel cell system. The fuel cell system includes the hydrogen circulation pump 1, the hydrogen tank 2, which is a hydrogen supply source, a fuel cell stack 4, a compressor 12, which supplies oxidizing gas, and a gas-liquid separator 14. The hydrogen tank 2 stores high-pressure hydrogen. The fuel cell stack 4 is a stack of fuel battery cells.

The hydrogen supply passage 6 connects the hydrogen tank 2 to the fuel cell stack 4. The hydrogen supply passage 6 is a passage through which hydrogen is supplied from the hydrogen tank 2 to the fuel cell stack 4. The hydrogen supply passage 6 is a passage originally formed differently from the hydrogen recirculation passage 8 in supplying hydrogen. The hydrogen supply passage 6 includes the upstream supply pipe 6a and a downstream supply pipe 6b. The hydrogen supply passage 6 may further include the cooling chamber 11a, the shaft passage 31a, the connection passage 3a, and the discharge passage 5c, which are laid out in this order between the upstream supply pipe 6a and the downstream supply pipe 6b. The upstream supply pipe 6a connects the hydrogen tank 2 to the inflow port 11b of the hydrogen circulation pump 1. The upstream supply pipe 6a includes a hydrogen shut-off valve 6c and a hydrogen supply adjustment valve 6d. The downstream supply pipe 6b connects the discharge passage 5c of the hydrogen circulation pump 1 to the fuel cell stack 4. The upstream supply pipe 6a and the downstream supply pipe 6b are hydrogen supply pipes. The hydrogen circulation pump 1 is arranged on the hydrogen supply pipe, for example, between the upstream supply pipe 6a and the downstream supply pipe 6b.

The hydrogen recirculation passage 8 connects the fuel cell stack 4 to the hydrogen circulation pump 1. The hydrogen recirculation passage 8 includes a hydrogen recirculation pipe 8a. The hydrogen recirculation passage 8 further includes the intake passage 5b, the pump chamber 5a, and the discharge passage 5c in the pump 1. The hydrogen recirculation pipe 8a connects the fuel cell stack 4 to the intake passage 5b of the hydrogen circulation pump 1. The hydrogen recirculation pipe 8a may include the gas-liquid separator 14.

When the hydrogen shut-off valve 6c opens, the hydrogen in the hydrogen tank 2 is supplied to the hydrogen circulation pump 1 through the upstream supply pipe 6a and supplied to the fuel cell stack 4 through the downstream supply pipe 6b. The hydrogen supply adjustment valve 6d adjusts the supply amount of hydrogen. The compressor 12 supplies oxidizing gas to the fuel cell stack 4. In the fuel cell stack 4, electricity is generated through the electrochemical reaction of hydrogen and oxygen in the oxidizing gas. Exhaust gas containing hydrogen that has not been used in the fuel cell stack 4 flows through the hydrogen recirculation pipe 8a to the gas-liquid separator 14. The gas-liquid separator 14 discharges, to the outside, water generated through the chemical reaction. The exhaust gas excluding the water is delivered through the hydrogen recirculation pipe 8a by driving the hydrogen circulation pump 1. The gas containing hydrogen discharged to the downstream supply pipe 6b by the hydrogen circulation pump 1 is supplied to the fuel cell stack 4 again. More specifically, the exhaust gas is drawn into the pump chamber 5a from the intake passage 5b through the hydrogen recirculation pipe 8a of the hydrogen recirculation passage 8 and flows through the discharge passage 5c into the downstream supply pipe 6b. Thus, the fuel cell system reduces wasteful consumption of hydrogen by recirculating exhaust gas containing hydrogen that has not been used in the fuel cell stack 4.

The hydrogen in the hydrogen tank 2 flows into the cooling chamber 11a through the upstream supply pipe 6a of the hydrogen supply passage 6 and the inflow port 11b. Then, the hydrogen flows through the outflow port 11c, the shaft passage 31a, and the connection passage 3a and merges with exhaust gas in the discharge passage 5c. That is, the hydrogen supply passage 6, which connects the hydrogen tank 2 to the fuel cell stack 4, merges with the hydrogen recirculation passage 8, where the hydrogen circulation pump 1 should be originally arranged. Accordingly, the hydrogen that has flowed through the connection passage 3a flows into the downstream supply pipe 6b through the discharge passage 5c together with the exhaust gas. That is, hydrogen flows into the housing from the inflow port 11b, passes through the merge portion 10, and is discharged (flows out) from the discharge port 5c. The hydrogen in the hydrogen tank 2 has a lower temperature than the exhaust gas. The low-temperature hydrogen supplied from the hydrogen tank 2 cools the partition wall 11e in the cooling chamber 11a. Then, the partition wall 11e cools the inverter I. This causes heat to be exchanged through the partition wall 11e between the low-temperature hydrogen and the inverter I, which has been heated when activated.

When the merge portion 10 is arranged downstream of the pump body P, hydrogen can be used as coolant for cooling even if the setting of the pump body P is not greatly changed. Thus, hydrogen can be easily used as coolant. Further, the cooling chamber 11a is arranged between the motor M and the inverter I. Furthermore, the cooling chamber 11a includes the fins 11d. Thus, low-temperature hydrogen flowing through the cooling chamber 11a effectively absorbs the heat from the motor M and the inverter I and effectively cools the motor M and the inverter I. This limits heating of the inverter I even if the motor M and the inverter I are both accommodated in the common housing or accommodated in the vicinity of each other. Additionally, the low-temperature hydrogen in the shaft passage 31a limits the generation of heat caused by frictional heat of the first rotation shaft 31. This improves the durability of the hydrogen circulation pump 1.

Thus, the hydrogen circulation pump 1 and the fuel cell system of the first embodiment are excellent in the mountability for a device such as a vehicle and reduce deterioration in the durability. Further, in the hydrogen circulation pump 1 and the fuel cell system of the first embodiment, hydrogen supplied from the hydrogen tank 2 (i.e., hydrogen prior to circulating) is used to cool the inverter I. This eliminates the need to supply coolant from, for example, a water pump in order to cool the inverter I. Also, as compared to when the inverter I is cooled by using hydrogen and coolant in combination, the load on the water pump can be reduced. Since the molecule of hydrogen is small, the influence of pressure loss is small. This reduces the space between the fins 11d in the cooling chamber 11a and increases the number of the fins 11d as compared to a water jacket that causes coolant to flow. As a result, the cooling effect is further increased.

Second Embodiment

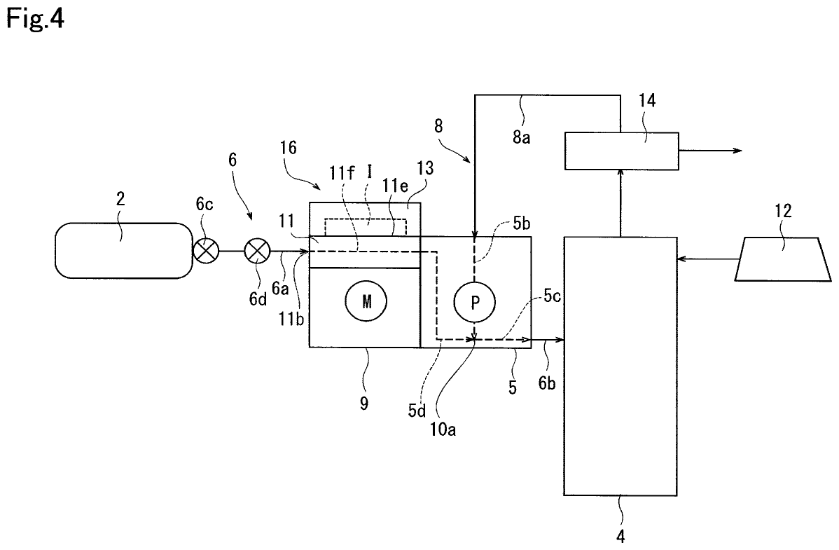

As shown in FIG. 4, the fuel cell system of the second embodiment includes a hydrogen circulation pump 16, which has a configuration that differs from the configuration of the hydrogen circulation pump 1 of the first embodiment. More specifically, the motor M and the pump body P, which share the first rotation shaft 31, are arranged next to each other. Further, the pump housing member 5 and the motor housing member 9 are arranged next to each other. In addition, the inverter I is mounted on the side surface (upper surface) of the motor M, and the cooling chamber 11a is arranged between the motor M and the inverter I.

The cooling housing member 11 includes a cooling chamber 11f. The pump housing member 5 includes a connection passage 5d, which is connected to the cooling chamber 11f. The hydrogen supply passage 6 includes the upstream supply pipe 6a and the downstream supply pipe 6b. The hydrogen supply passage 6 further includes the cooling chamber 11f of the hydrogen circulation pump 16, the connection passage 5d, and the discharge passage 5c. The hydrogen circulation pump 16 of the second embodiment does not include the shaft passage 31a of the first embodiment. That is, the hydrogen supply passage 6 merges with the hydrogen recirculation passage 8 at the merge portion 10, where the connection passage 5d merges with the discharge passage 5c. The other configurations are the same as those of the first embodiment.

In this fuel cell system, the partition wall 11e is located between the motor M and the inverter I. Thus, the fuel cell system of the second embodiment does not have the advantage gained by the shaft passage 31a of the first embodiment. Otherwise, the fuel cell system of the second embodiment has the same advantages as the fuel cell system of the first embodiment.

Third Embodiment

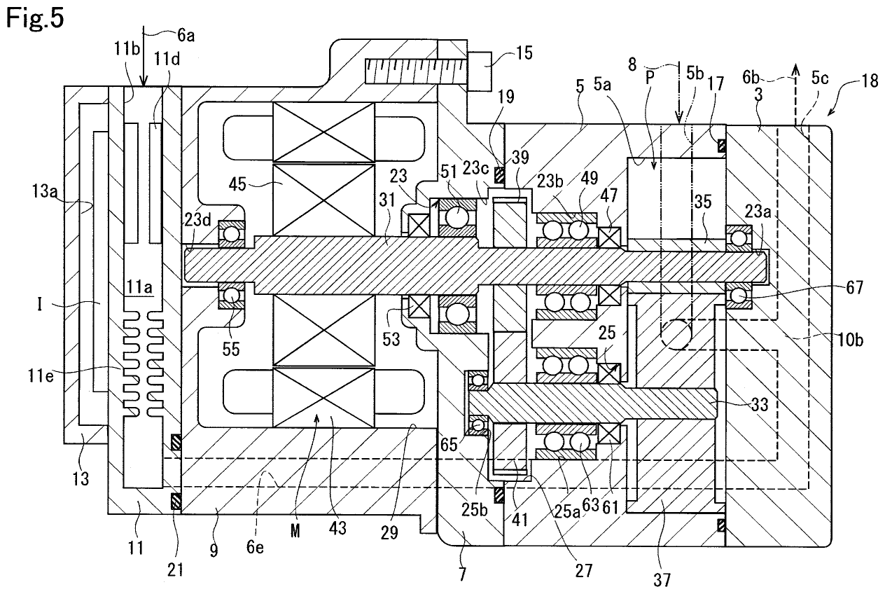

As shown in FIG. 5, the fuel cell system of the third embodiment includes a hydrogen circulation pump 18. The hydrogen circulation pump 18 includes a connection passage 6e. The connection passage 6e extends through the cooling housing member 11, the motor housing member 9, the center housing member 7, the pump housing member 5, and the end housing member 3. The connection passage 6e connects the cooling chamber 11a to the discharge passage 5c. The connection passage 6e is connected to the discharge passage 5c at the merge portion 10. The shaft hole 23a of the hydrogen circulation pump 18 has a closed end, which is the right end in FIG. 5. In the same manner as the second embodiment, the first rotation shaft 31 of the third embodiment does not include the shaft passage 31a. Further, the chip seals 57 and 59 of the first embodiment are not arranged respectively between the end housing member 3 and the first rotation shaft 31 and between the motor housing member 9 and the first rotation shaft 31. A bearing 67 is arranged between the end housing member 3 and the first rotation shaft 31. The other configurations are the same as those of the first and second embodiments.

The fuel cell system of the third embodiment has the same advantages as the first and second embodiments.

The features disclosed in the first to third embodiments may all be modified as necessary without departing from the scope of the invention.

For example, in the first to third embodiments, the hydrogen supply passage 6, which is connected to the hydrogen tank 2, includes the cooling chamber 11a, which extends near the inverter I. Instead, for example, a passage that does not include the fins 11d may be set as a hydrogen supply passage.

In the first to third embodiments, the merge portions 10, 10a, and 10b of the hydrogen supply passage 6 and the hydrogen recirculation passage 8 are arranged downstream of the pump body P. Instead, the merge portions may be arranged upstream of the pump body.

The positions of the motor M and the pump body P may be changed. For example, in the first embodiment, the arrangement of the motor M and the pump body P may be reversed. In the first to third embodiments, hydrogen passes through the cooling chamber and then flows through the housing along the first axis. Instead, for example, the inflow port may be arranged at one end of the partition wall, and the merge portion may be arranged at the other end of the partition wall. In this case, low-temperature hydrogen flows through the inflow port into the cooling chamber. Further, the hydrogen flows along the partition wall and then merges with the hydrogen recirculation passage. The hydrogen circulation pump and the downstream supply passage (downstream supply pipe) may be arranged downstream of the merge portion.

The hydrogen supply source may have a configuration that differs from the configuration of the hydrogen tank 2.

The hydrogen supply passage 6 connected to the hydrogen tank 2 may include a first branch passage, which extends through the hydrogen circulation pumps 1, 16, and 18, and a second branch passage, which is directly connected to the fuel cell stack 4.

The hydrogen circulation pump for the fuel cell system and the fuel cell system of the present disclosure are applicable to, for example, an electric vehicle.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

### EXAMPLE

A hydrogen circulation pump for a fuel cell system according to one aspect of the present disclosure includes a pump body configured to deliver hydrogen, a motor configured to drive the pump body, a driver configured to control the motor, and a housing that accommodates the pump body, the motor, and the driver. The housing internally includes a hydrogen recirculation passage, a hydrogen supply passage, and a partition wall. The hydrogen recirculation passage connects the pump body to a fuel cell stack and includes an intake port into which the pump body draws the hydrogen from the fuel cell stack. Hydrogen is supplied from a hydrogen supply source to the fuel cell stack through the hydrogen supply passage. The partition wall defines an accommodation chamber accommodating the driver. The hydrogen supply passage includes an inflow port through which hydrogen flows into the housing, a merge portion where the hydrogen supply passage merges with the hydrogen recirculation passage, and a discharge port arranged downstream of the merge portion. Hydrogen from the inflow port through the merge portion is discharged from the discharge port. The hydrogen supply passage is arranged in the housing such that heat is exchanged at an upstream side of the merge portion through the partition wall between the driver and the hydrogen in the hydrogen supply passage.

The electrochemical reaction in the cells of the fuel cell is a heat-generating reaction. Thus, exhaust gas containing hydrogen that has not been used in the fuel cell stack has a higher temperature than hydrogen that is directly supplied from the hydrogen supply source. The hydrogen having a lower temperature than the exhaust gas cools the driver. Thus, the cooling efficiency is high. This limits heating of the driver even if the motor and the driver are accommodated in the housing.

Accordingly, the hydrogen circulation pump of the present disclosure has an excellent mountability for a device such as a vehicle and reduces deterioration in the durability.

In some embodiments, the merge portion may be located downstream of the pump body. When the merge portion is located upstream of the pump body, the use of hydrogen for cooling requires setting of the pump body (for example, changing the setting of output). In this regard, when the pump body is located downstream of the pump body, the setting of the pump body does not need to be significantly changed. Thus, hydrogen can be easily used for cooling.

In some embodiments, the partition wall may be located between the motor and the driver. In this case, low-temperature hydrogen can cool both the motor and the driver.

In some embodiments, the pump body and the motor may include a rotation shaft arranged in the housing. In some embodiments, the rotation shaft may internally include a shaft passage that is part of the hydrogen supply passage. In this case, the low-temperature hydrogen in the shaft passage effectively cools the motor and the driver. Further, the low-temperature hydrogen in the shaft passage limits the generation of heat caused by frictional heat of the rotation shaft and improves the durability of the hydrogen circulation pump.

In some embodiments, the hydrogen supply passage may include a cooling chamber. In some embodiments, fins may be arranged in the cooling chamber. The arrangement of the fins increases the contact area of the fins and hydrogen. Thus, low-temperature hydrogen effectively absorbs heat from the driver.

A hydrogen circulation pump according to one aspect of the present disclosure includes a pump body, a motor configured to drive the pump body, a driver configured to control the motor, and a housing that accommodates the pump body, the motor, and the driver. The housing internally includes part of a hydrogen supply passage that connects a hydrogen supply source to a fuel cell stack, part of a hydrogen recirculation passage that connects the pump body to the fuel cell stack, a merge portion where the hydrogen supply passage merges with the hydrogen recirculation passage, a cooling chamber arranged in the hydrogen supply passage at an upstream side of the merge portion, and a partition wall defining an accommodation chamber that accommodates the driver. The partition wall is arranged between the cooling chamber and the driver.

A fuel cell system according to one aspect of the present disclosure includes a hydrogen supply source, a fuel cell stack, a hydrogen supply pipe that connects the hydrogen supply source to the fuel cell stack, a hydrogen recirculation pipe connected to the fuel cell stack, and a hydrogen circulation pump. The hydrogen recirculation pipe recirculating exhaust gas contains hydrogen from the fuel cell stack. The hydrogen circulation pump is configured to supply the fuel cell stack with the exhaust gas in the hydrogen recirculation pipe. The hydrogen circulation pump includes a pump body configured to deliver hydrogen, a motor configured to drive the pump body, a driver configured to control the motor, and a housing that accommodates the pump body, the motor, and the driver. The housing internally includes part of a hydrogen recirculation passage connecting the pump body to the fuel cell stack. The hydrogen recirculation passage includes an intake port into which the pump body draws the hydrogen from the fuel cell stack, part of a hydrogen supply passage through which hydrogen is supplied from the hydrogen supply source to the fuel cell stack, and a partition wall that defines an accommodation chamber accommodating the driver. The hydrogen recirculation passage includes the hydrogen recirculation pipe. The hydrogen supply passage includes the hydrogen supply pipe. The hydrogen supply passage in the housing includes an inflow port through which hydrogen flows into the housing, a merge portion where the hydrogen supply passage merges with the hydrogen recirculation passage in the housing, and a discharge passage arranged downstream of the merge portion. The hydrogen supply passage in the housing is arranged such that heat is exchanged at an upstream side of the merge portion through the partition wall between the driver and the hydrogen in the hydrogen supply passage.

In the fuel cell system of the present disclosure, the driver is cooled by hydrogen that is supplied directly from the hydrogen supply source, not by hydrogen that has passed through the hydrogen recirculation pipe. This limits heating of the driver even if the motor and the driver are accommodated in the housing.

Accordingly, the fuel cell system of the present disclosure has an excellent mountability and reduces deterioration in the durability.

1. A hydrogen circulation pump for a fuel cell system, the hydrogen circulation pump comprising:
a pump body configured to deliver hydrogen;
a motor configured to drive the pump body;
a driver configured to control the motor; and
a housing that accommodates the pump body, the motor, and the driver, wherein the housing internally includes
a hydrogen recirculation passage connecting the pump body to a fuel cell stack, the hydrogen recirculation passage including an intake port into which the pump body draws the hydrogen from the fuel cell stack,
a hydrogen supply passage through which hydrogen is supplied from a hydrogen supply source to the fuel cell stack, and
a partition wall that defines an accommodation chamber accommodating the driver,
the hydrogen supply passage includes
an inflow port through which hydrogen flows into the housing,
a merge portion where the hydrogen supply passage merges with the hydrogen recirculation passage, and
a discharge port arranged downstream of the merge portion, wherein hydrogen from the inflow port through the merge portion is discharged from the discharge port, and
the hydrogen supply passage is arranged in the housing such that heat is exchanged at an upstream side of the merge portion through the partition wall between the driver and the hydrogen in the hydrogen supply passage.

2. The hydrogen circulation pump according to claim 1, wherein the merge portion is located downstream of the pump body.

3. The hydrogen circulation pump according to claim 1, wherein the partition wall is located between the motor and the driver.

4. The hydrogen circulation pump according to claim 1, wherein
the pump body and the motor include a rotation shaft arranged in the housing, and
the rotation shaft internally includes a shaft passage that is part of the hydrogen supply passage.

5. The hydrogen circulation pump according to claim 1, wherein
the hydrogen supply passage includes a cooling chamber, and
fins are arranged in the cooling chamber.

6. A hydrogen circulation pump comprising:
a pump body;
a motor configured to drive the pump body;
a driver configured to control the motor; and
a housing that accommodates the pump body, the motor, and the driver, wherein
the housing internally includes
part of a hydrogen supply passage that connects a hydrogen supply source to a fuel cell stack,
part of a hydrogen recirculation passage that connects the pump body to the fuel cell stack,
a merge portion where the hydrogen supply passage merges with the hydrogen recirculation passage,
a cooling chamber arranged in the hydrogen supply passage at an upstream side of the merge portion, and
a partition wall defining an accommodation chamber that accommodates the driver , the partition wall being arranged between the cooling chamber and the driver.

7. A fuel cell system comprising:
a hydrogen supply source;
a fuel cell stack;
a hydrogen supply pipe that connects the hydrogen supply source to the fuel cell stack;
a hydrogen recirculation pipe connected to the fuel cell stack, the hydrogen recirculation pipe recirculating exhaust gas that contains hydrogen from the fuel cell stack; and
a hydrogen circulation pump configured to supply the fuel cell stack with the exhaust gas in the hydrogen recirculation pipe, wherein
the hydrogen circulation pump includes
a pump body configured to deliver hydrogen,
a motor configured to drive the pump body,
a driver configured to control the motor, and
a housing that accommodates the pump body, the motor, and the driver,
the housing internally includes
part of a hydrogen recirculation passage connecting the pump body to the fuel cell stack, wherein the hydrogen recirculation passage includes an intake port into which the pump body draws the hydrogen from the fuel cell stack,
part of a hydrogen supply passage through which hydrogen is supplied from the hydrogen supply source to the fuel cell stack, and
a partition wall that defines an accommodation chamber accommodating the driver,
the hydrogen recirculation passage includes the hydrogen recirculation pipe,
the hydrogen supply passage includes the hydrogen supply pipe,
the hydrogen supply passage in the housing includes
an inflow port through which hydrogen flows into the housing,
a merge portion where the hydrogen supply passage merges with the hydrogen recirculation passage in the housing, and
a discharge passage arranged downstream of the merge portion, and
the hydrogen supply passage in the housing is arranged such that heat is exchanged at an upstream side of the merge portion through the partition wall between the driver and the hydrogen in the hydrogen supply passage.
